(19) United States
(12) Patent Application Publication
(10) Pub. No.: US 2019/0023418 A1
(43) Pub. Date: Jan. 24, 2019

(54) DEVICE AND METHOD FOR MANAGING DRONE

(71) Applicant: Jin Seok RO, Incheon (KR)

(72) Inventor: Jin Seok RO, Incheon (KR)

(21) Appl. No.: 16/033,185

(22) Filed: Jul. 11, 2018

(30) Foreign Application Priority Data
Jul. 21, 2017 (KR) 10-2017-0092853

(51) Int. Cl. B64F 5/40; B64F 5/60; B64F 1/36; H02J 7/00; G06K 9/62; G06T 7/00; G06T 1/00; G06T 7/40; B08B 3/08; B08B 3/02; B08B 5/02

(52) U.S. Cl. CPC B64F 5/40; B64F 5/60; B64F 1/362; H02J 7/0052; G06K 9/6267; G06T 7/0008; B08B 2230/01; G06T 7/40; B08B 3/08; B08B 3/02; B08B 5/02; G06T 2207/30156; G06T 1/0014

(57) ABSTRACT

Provided is a drone management device and method. The device includes: a primary inspection module configured to measure a weight of a drone in order to determine the loss of a component and the presence of foreign matter in the landed drone after flight and classify the drone into a failed drone and a normal drone; a cleaning/drying module configured to measure a degree of contamination of the classified normal drone, cleaning the drone according to a degree of the measured drone contamination; a secondary inspection module configured to photograph the front, side, rear surfaces of the drone with a camera, detect an abnormality of a component mounted on the drone with the photographed image, and classify the drone into a failed drone and a normal drone; and a take-off preparation module configured to charge a battery of the normal drone.

### CROSS-REFERENCE TO RELATED APPLICATIONS

This U.S. non-provisional patent application claims priority under 35 U.S.C. § 119 of Korean Patent Application No. 10-2017-0092853, filed on Jul. 21, 2017 the entire contents of which are hereby incorporated by reference.

### BACKGROUND

The present disclosure relates to a drone management device and method, and more particularly, to a drone management device and method for automatically and safely managing a plurality of drones.

Unless otherwise indicated in this specification, the contents of this section are not prior art to the claims of this application and even when the contents are included in the section, they are not recognized as a prior art.

Drone, as an unmanned aircraft, is a flight craft designed to perform the assigned mission without boarding a pilot. Drones may operate in conjunction with independent systems or space/ground systems. The drones perform various missions such as surveillance, reconnaissance, precise attack weapon induction, communication/information relay, EA/EP, Decoy, etc. with various devices such as optical, infrared, radar, and sensors. In addition, drones are loaded with explosives and developed as precision weapons themselves, so that they receive attention as a major military force in the future. These drones are being used not only in military but also in various fields.

However, since there are not many agencies to manage a large number of drones, individual drones are kept in a box form, and many drones are not managed. In addition, there is no system to automatically charge, inspect, and manage several drones that land after the flight.

In the current method of managing individual drone, it is difficult to manage a large number of drones when a large number of drones are required in accordance with the social demand increase in the future. Especially, when the use of drones is increasing in public such as military and social safety, it is difficult to monitor and manage the drones in real time, such as identification of multiple drones, management of abnormalities, and charge status management.

### SUMMARY

The present disclosure is to provide a drone management device and method for identifying various drones after the drone landing, checking the device conditions to determine whether the drone component is lost or broken and repairing the drone if broken, and automatically preparing safe takeoff after cleaning each drone.

An embodiment of the inventive concept provides a drone management device including: a primary inspection module configured to measure a weight of a drone in order to determine the loss of a component and the presence of foreign matter in the landed drone after flight and classify the drone into a failed drone and a normal drone according to a measurement result; a cleaning/drying module configured to measure a degree of contamination of the classified normal drone, cleaning the drone according to a degree of the measured drone contamination; a secondary inspection module configured to photograph the front, side, rear surfaces of the drone with a camera, detect an abnormality of a component mounted on the drone with the photographed image, and classify the drone into a failed drone and a normal drone; and a take-off preparation module configured to charge a battery of the normal drone classified after the secondary inspection and confirm the weight of the completely charged drone.

In an embodiment of the inventive concept, a drone management method includes: (A) measuring, by a primary inspection module, a weight of a landed drone in order to determine whether a component of the drone is lost and whether there is foreign material, and classifying the drone into a failed drone and a normal drone; (B) cleaning and drying, by a secondary inspection module, the classified normal drone; (C) photographing the front, side, and rear surfaces of the cleaned and dried drone with a camera and detecting whether the component of the drone is normal with the photographed image to classify it into a failed drone and a normal drone; and (D) charging, by a take-off preparation module, a battery of the normal drone classified in the secondary inspection module and checking a weight of the charged drone.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating a drone management system according to an embodiment;

FIG. 2 is a view illustrating a schematic configuration of a drone management device according to an embodiment;

FIG. 3 is a view illustrating a more specific configuration of a drone management device according to an embodiment;

FIG. 4 is a flowchart illustrating a drone management flow according to an embodiment; and

FIG. 5 is a flowchart illustrating a specific drone management flow according to an embodiment.

### DETAILED DESCRIPTION

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numbers refer to like elements throughout the entire specification.

Additionally, in describing the present invention, detailed descriptions of well-known configurations or functions will be omitted if it is determined that they would obscure the subject matter of the present invention. Then, the following terms are defined in consideration of the functions in the embodiments of the present invention, and this may vary depending on the intention of the user, the operator, or the custom. Therefore, the definition should be based on the contents throughout this specification.

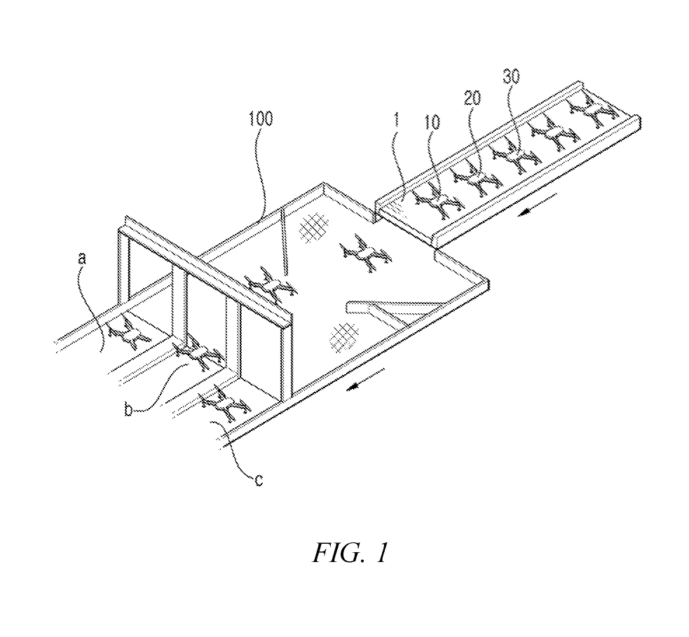

FIG. 1 is a view illustrating a drone management system according to an embodiment.

Referring to FIG. 1, the drone management system may include a conveyor belt 1, a drone management device 100, and sorting lines a, b, and c.

The conveyor belt 1 sequentially moves a plurality of drones 10, 20 and 30 into the drone management device 100. The drone management device 100 examines the device conditions of the entered drone and the failure of the components attached to the drone, and classifies the drone according to the result of the inspection. For example, after the drone weight inspection, a drone inspection device 100 may classify the failed drones and the normal drones so that it may allow the failed drones to enter the drone repair line a and the normal drones to enter the drone cleaning line c. In addition, the drone, which is determined to require more precise inspection, enters the drone check line b, thereby allowing the drone to enter the check line b to perform a precise machine inspection.

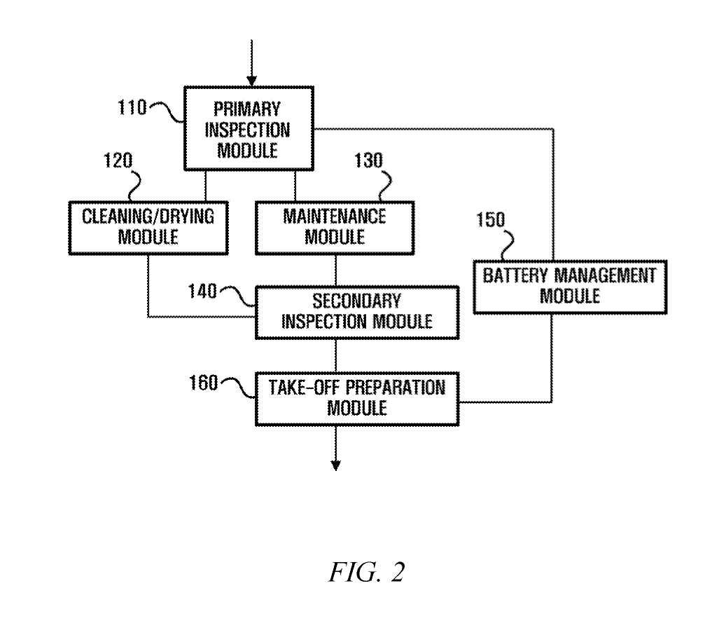

FIG. 2 is a view illustrating a schematic configuration of a drone management device 100 according to an embodiment.

Referring to FIG. 2, the drone management device 100 includes a database (not shown), a primary inspection module 110, a cleaning/drying module 120, a maintenance module 130, a secondary inspection module 140, a battery management module 150, and a take-off preparation module 160. The term “module”, as used herein, should be interpreted to include software, hardware, or a combination thereof, depending on the context in which the term is used. For example, the software may be machine language, firmware, embedded code, and application software. As another example, the hardware may be a circuit, a processor, a computer, an integrated circuit, an integrated circuit core, a sensor, a micro-electro-mechanical system (MEMS), a passive device, or a combination thereof.

Although not implemented in FIG. 2, the drone management device 100 may further include a control unit. Such a control unit, for example, may control the overall operation, such as power supply control of the drone management device 100, and the signal flow between the internal configurations of the drone management device 100, and perform data processing functions for processing data. The control unit may include at least one processor or Micro Controller Unit (MCU). Such a control unit may be a subject for performing an arithmetic operation or a determination operation in the primary inspection module 110, the cleaning/drying module 120, the maintenance module 130, the secondary inspection module 140, the battery management module 150, and the take-off preparation module. Such a control unit may be separately configured, or may be provided in a form that itself is included in each configuration of the drone management device 100.

The database stores device information according to the drone model. For example, the device information stores a series of data necessary for the operation of the drone management device described herein, including the drone model name, the weight for each drone model, the type of the mounted component, and the front, side, and rear images. According to one embodiment, the database may be implemented in memory. The memory may store data received or generated from the control unit or other components of the drone management device 100. The memory may include cache, buffer, etc., and may be composed of software (e.g., DB), firmware, hardware (e.g., RAM), or a combination of at least two thereof.

The primary inspection module 110 measures the weight of the landed drone in order to determine whether the landing drone have lost components and whether or not there is a foreign object. For example, the primary inspection module 110 may compare the drone weight after landing and the pre-stored normal drone weight to determine whether the drone is abnormal according to the comparison result. For this, the primary inspection module 110 may include means for measuring the weight, such as a weight sensor. Specifically, if the drone weight is lower than a normal drone weight by a certain level, the primary inspection module 110 may determine that the drone loses a specific component. If the measured drone weight exceeds the normal drone weight by more than a certain level, it may be determined that foreign substances such as branches are added to the drones.

The cleaning/drying module 120 cleans and dries the normal drone among the drones classified by the primary inspection module 110 according to the contamination degree of the drone.

The maintenance module 130 maintains the failed drone among the drones classified in the primary inspection module 110. For example, a failed drone having a weight lower than the normal weight is maintained by replacing the damaged component. The drone having a weight exceeding the normal weight undergoes a maintenance process for removing the foreign substance added to the drone, and then enters the primary inspection module 110.

The secondary inspection module 140 determines whether the components mounted on the drone are failed. For example, the secondary inspection module 140 photographs the front, side, and rear of the drone with the camera, compares the photographed image with the pre-stored drone component image, and detects whether the component mounted on the drone is abnormal according to the comparison result. Subsequently, the drones with no component failure are classified as normal drones. Drones classified as failed drones in the secondary inspection module 140 enter the maintenance module 130 and undergo the repair process of the faulty component.

The take-off preparation module 160 charges the battery of the normal drone classified after the second inspection and confirms the weight of the charged drone again. For this, the take-off preparation module 160 may have a power supply (not shown) for charging the battery, or may be connected to the power supply.

In an embodiment, the battery management module 150 of the drone management device may remove the battery of the drones landing after the flight, before the primary failure inspection in the first inspection module 110, and after charging the detached battery, mount it on the normal drone of the take-off preparation module 160. For this, the battery management module 150 may include an automated mechanical detachment control device for battery detachment.

Although not shown in FIG. 2, the drone management device 100 may further include a camera module. Such a camera module may be connected to at least a portion of the configuration of the drone management device 100 to collect image information on the drone. For example, the cleaning/drying module 120 and the secondary inspection module 140 may perform contamination measurement and component image comparison through the camera module. However, the present invention is not limited thereto, and the camera module may be provided by itself in each configuration of the drone management device 100.

In addition, the drone management device 100 may further include a communication module (not shown). Such a communication module may communicate with the drones, for example, via wireless communication or wired communication. Wireless communication may include, for example, at least one of a network, wireless fidelity (WiFi), Bluetooth (BT), near field communication (NFC), global positioning system (GPS), ZigBee, RF communication, but is not limited thereto.

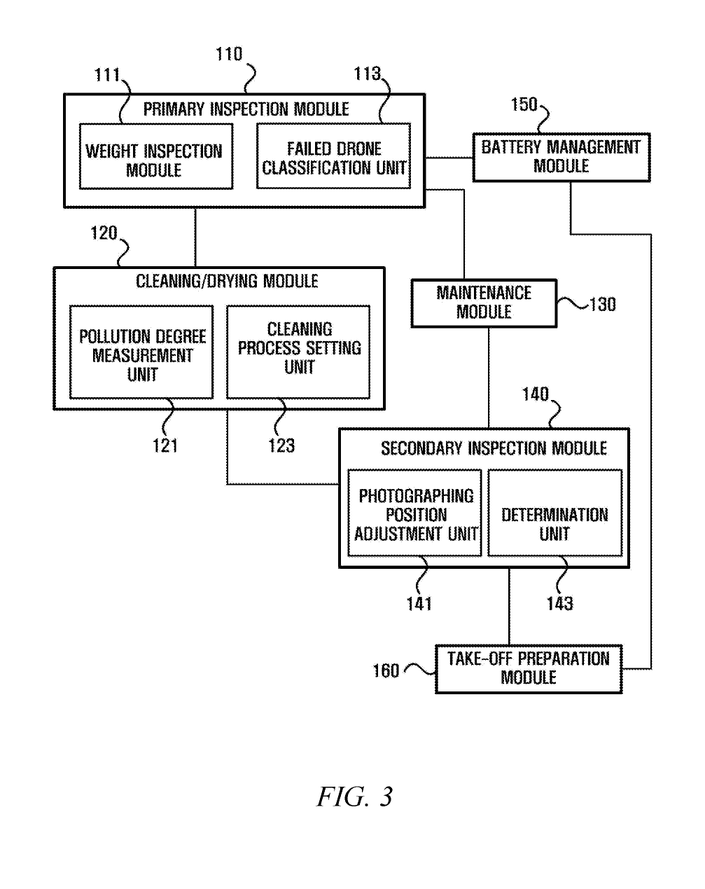

FIG. 3 is a view illustrating a more specific configuration of a drone management device 100 according to an embodiment.

Referring to FIG. 3, a primary inspection module 110 may include a weight inspection unit 111 and a failed drone classification unit 113. The cleaning/drying module 120 may include a pollution degree measurement unit 121 and a cleaning process setting unit 123. The secondary inspection module 140 may include a photographing position adjustment unit 141 and a determination unit 143.

The weight inspection unit 111 of the primary inspection module 110 measures the weight of each drone after landing. The failed drone classification unit 113 compares the measured drone weight with the pre-stored normal drone weight and determines whether the drone is abnormal according to the comparison result. In an embodiment, the failed drone classification unit 113 may classify a drone having a measured drone weight and normal drone weight error exceeding a certain level as a failed drone.

The pollution degree measurement unit 121 of the cleaning/drying module 120 obtains the drone surface image and calculates the degree of contamination so as to be in inverse proportion to the sharpness of the drone surface. For example, the degree of contamination may be calculated by measuring the sharpness of the drone surface image color or the degree of recognition of the drone surface graphic. Also, the pollution degree measurement unit 121 may measure the pollution degree of the surface of the drones by a harmful substance detection sensor or a camera module.

The cleaning process setting unit 123 sets the drones cleaning process based on the pollution degree calculated in the pollution degree measurement unit 121. For example, the cleaning process setting unit 123 may set a cleaning process including at least one of wind cleaning, steam cleaning, water cleaning, and detergent cleaning according to the degree of contamination. Specifically, the cleaning process setting unit 123 may be configured to include a plurality of cleaning processes as the contamination degree is higher.

The photographing position adjustment unit 141 of the secondary inspection module 140 adjusts the position of the drone and the camera and the photographing detail setting of the camera for photographing the drones mounted on the front, side, and rear surfaces thereof. For example, the camera focal length and angle, the angle of the drone, and the like may be adjusted for photographing the main components mounted on each side of the drone.

The determination unit 143 compares the photographed drone component image with the pre-stored normal component image to determine whether there is a defect according to the error rate of the photographed drone component image and the normal component image. The determination unit 143 may operate as a control unit as a functional classification of the control unit described above.

Hereinafter, a drone management method will be described in turn. Since the function (function) of a drone management method according to the present invention is essentially the same as that of the drone management device, a description overlapping with FIGS. 1 to 3 will be omitted.

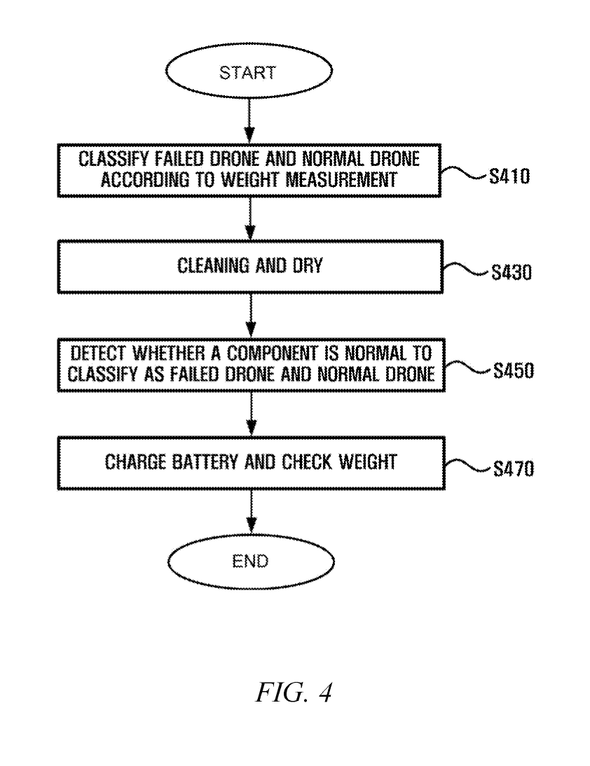

FIG. 4 is a flowchart illustrating a drone management flow according to an embodiment.

According to an embodiment, the drone management method includes: (A) measuring, by a primary inspection module, a weight of a landed drone in order to determine whether a component of the drone is lost and whether there is foreign material, and classifying the drone into a failed drone and a normal drone (S410); (B) cleaning and drying, by a secondary inspection module, the classified normal drone (S430); (C) photographing the front, side, and rear surfaces of the cleaned and dried drone with a camera and detecting whether the component of the drone is normal with the photographed image to classify it into a failed drone and a normal drone (S450); and (D) charging, by a take-off preparation module, a battery of the normal drone classified in the secondary inspection module and checking a weight of the charged drone (S470).

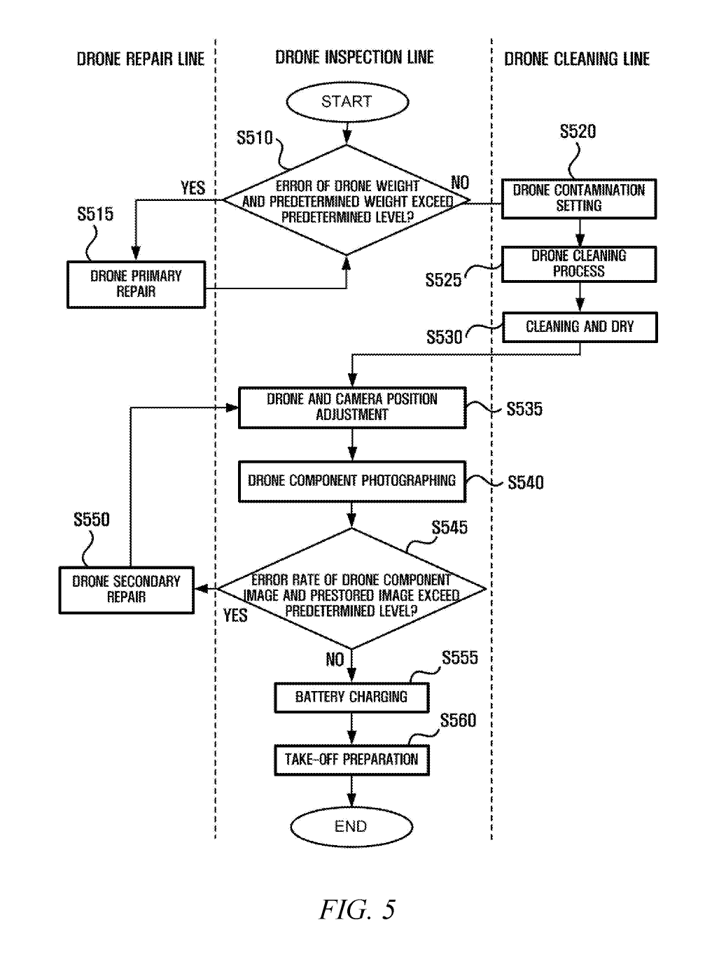

FIG. 5 is a flowchart illustrating a specific drone management flow according to an embodiment.

In operation S510, the primary inspection module 110 determines whether the error of the weight of the drone weight and the weight of the predetermined normal drone exceeds a predetermined level.

If the error exceeds the predetermined level, in operation S515, the maintenance module 130 performs a primary repair of the drone, such as supplementing the lost component or removing foreign matter added to the drones.

If the error between the weight of the drone and the predetermined weight is less than the predetermined level, the cleaning/drying module 120 measures the contamination of the drone in operation S520. In an embodiment, the drone pollution degree may be calculated by recognizing the sharpness of the surface of the drone or based on the data detected by the hazardous material detection sensor.

In operation S525, the cleaning/drying module 120 sets a drone cleaning process including at least one of various cleaning processes according to the calculated contamination level. For example, it may be set to include a plurality of cleaning processes in proportion to the degree of contamination. In operation S530, the drones are cleaned and dried according to the set cleaning process.

The cleaned drone enters operation S535 for more careful troubleshooting. In step S535, the positions of the drone and the camera are adjusted in the secondary inspection module 140. In operation S540, the components attached to the front, side, and rear surfaces of the drone are photographed.

In operation S545, the error rate is calculated according to the degree of coincidence between the image of the drone component photographed by the secondary inspection module 140 and the pre-stored image, and it is determined whether the calculated error rate is equal to or higher than a predetermined level. If the error rate is equal to or higher than a predetermined level, a process of repairing a component, which generates an error rate equal to or higher than the predetermined level, is performed in operation S550.

If the error rate is less than the predetermined level, the drone is determined to be a normal drone, and the battery of the determined normal drone is charged in operation S555. Thereafter, in operation S560, it is possible to prepare for take-off of the drone by mounting the completely charged battery or turning on the engine power of the drone.

A drone management device and method according this disclosure may identify various drones after the drone landing, and check the device conditions to determine whether the drone component is lost or broken and repair the drone if broken. In addition, after cleaning each drone, several drones may be safely and automatically managed to prepare for safe takeoff.

As above, the drone management device and method may automatically manage several drones safely by performing the primary and secondary failure inspection and washing and drying processes automatically after the drone landing.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A drone management device comprising:
a primary inspection module configured to measure a weight of a drone in order to determine the loss of a component and the presence of foreign matter in the landed drone after flight and classify the drone into a failed drone and a normal drone according to a measurement result;
a cleaning/drying module configured to measure a degree of contamination of the classified normal drone, cleaning the drone according to a degree of the measured drone contamination;
a secondary inspection module configured to photograph the front, side, rear surfaces of the drone with a camera, detect an abnormality of a component mounted on the drone with the photographed image, and classify the drone into a failed drone and a normal drone; and
a take-off preparation module configured to charge a battery of the normal drone classified after the secondary inspection and confirm the weight of the completely charged drone.

2. The drone management device of claim 1, wherein when an error between the measured drone weight and a pre-stored normal drone weight exceeds a predetermined level, the primary inspection module classifies the drone as a failed drone.

3. The drone management device of claim 1, further comprising a maintenance module configured to repair the failed drone classified in the primary inspection module.

4. The drone management device of claim 3, wherein the maintenance module repairs the failed drone classified in the secondary inspection module.

5. The drone management device of claim 1, further comprising a battery management module configured to detach the battery before the weight of the landed drone is measured, and after the detached battery is charged, mount the completely charged battery on the normal drone of the take-off preparation module.

6. The drone management device of claim 1, wherein the cleaning/drying module sets a cleaning process including at least one of a wind wash, a steam wash, a water wash, and a detergent wash to dry the landed drone after washing according to the set cleaning process based on a sharpness measurement result of the drone surface or a contamination degree measured by a pollution measurement sensor.

7. The drone management device of claim 1, wherein the secondary inspection module comprises:
a photographing position adjustment unit configured to adjust the positions of the drone and the camera and control the camera photographing setting to photograph drone components mounted on the front, side, and rear surfaces of the drone; and
a determination unit configured to compare the photographed drone component image with a previously stored normal component image to determine whether the component mounted on the drone is faulty according to an error rate of the photographed drone component image and the normal component image.

8. A drone management method comprising:
measuring, by a primary inspection module, a weight of a landed drone in order to determine whether a component of the drone is lost and whether there is foreign material, and classifying the drone into a failed drone and a normal drone;
cleaning and drying, by a secondary inspection module, the classified normal drone;
photographing the front, side, and rear surfaces of the cleaned and dried drone with a camera and detecting whether the component of the drone is normal with the photographed image to classify it into a failed drone and a normal drone; and
charging, by a take-off preparation module, a battery of the normal drone classified in the secondary inspection module and checking a weight of the charged drone.

9. The drone management method of claim 8, wherein measuring of the weight of the landed drone to classify it into the failed drone and the normal drone comprises:
comparing the weight of the landed drone with a predetermined value;
determining that the drone is a failed drone if an error between the weight of the landed drone and the predetermined value is equal to or greater than a predetermined level according to the comparison result; and
moving the determined failed drone to a maintenance module.

10. The drone management method of claim 8, detecting whether the component of the drone is normal to classify the drone into the failed drone and the normal drone comprises:
adjusting the positions of the drone and the camera to photograph the drone components mounted on the front, side, and rear surfaces of the drone and adjusting a photographing detail setting of the camera;
comparing the photographed drone component image with a pre-stored normal component image to determine whether the drone is normal according to an error rate of the photographed drone component image and the normal component image; and
moving the determined failed drone to a maintenance module.

11. The drone management method of claim 8, wherein measuring of the weight of the landed drone to classify it into the failed drone and the normal drone comprises:
detaching a battery of the landed drone; and
mounting the battery on the normal drone of the take-off preparation module after charging the detached battery.

12. The drone management method of claim 8, wherein cleaning and drying of the classified normal drone in the secondary inspection module comprises setting a cleaning process including at least one of a wind wash, a steam wash, a water wash, and a detergent wash to dry the landed drone after washing according to the set cleaning process based on a sharpness measurement result of the drone surface or a contamination degree measured by a pollution measurement sensor.
